(19) United States
(12) Patent Application Publication
(10) Pub. No.: US 2022/0330270 A1
(43) Pub. Date: Oct. 13, 2022

(54) RESOURCE ALLOCATION AND UPDATE FOR COMMUNICATING WITHIN SYNCHRONIZED TRANSMISSION OPPORTUNITIES (S-TXOPS)

(71) Applicants: Dibakar Das, Hillsboro, OR (US); Dave A. Cavalcanti, Portland, OR (US); Laurent Cariou, Milizac (FR); Dmitry Akhmetov, Hillsboro, OR (US); Daniel F. Bravo, Hillsboro, OR (US); Danny Alexander, Neve Efraim Monoson (IL); Ehud Reshef, Kiryat Tivon (IL)

(72) Inventors: Dibakar Das, Hillsboro, OR (US); Dave A. Cavalcanti, Portland, OR (US); Laurent Cariou, Milizac (FR); Dmitry Akhmetov, Hillsboro, OR (US); Daniel F. Bravo, Hillsboro, OR (US); Danny Alexander, Neve Efraim Monoson (IL); Ehud Reshef, Kiryat Tivon (IL)

(21) Appl. No.: 17/848,110

(22) Filed: Jun. 23, 2022

(51) Int. Cl. H04W 72/12

(52) U.S. Cl. CPC H04W 72/121; H04W 72/1289

(57) ABSTRACT

To communicate with a plurality of non-AP stations (STAs) within synchronized transmission opportunities (S-TXOPs), an access point station (AP) performs an initial management frame exchange with the STAs. During the initial management frame exchange, one or more sets of semi-static allocation parameters are signalling to the STAs. Each set of semi-static allocation parameters is associated with an allocation index (IDx). The AP may communicate data with the STAs during S-TXOPs that follow the initial management frame exchange. Each of the S-TXOPs may include an S-TXOP trigger. The S-TXOP trigger may be encoded to include one of the allocation indices to indicate a known allocation for use during the associated S-TXOP when a set of the predetermined semi-static allocation parameters are to be used. The S-TXOP trigger may be encoded to include full allocation information to indicate a new allocation for use during the associated S-TXOP when the predetermined semi-static allocation parameters are not used.

### RELATED APPLICATION

This application is related to U.S. patent application Ser. No. 17/824,520, filed May 25, 2022, entitled “ACCESS POINT CONFIGURED FOR SIGNALING CONFIGURATION AND RESOURCE ALLOCATION INSIDE A SYNCHRONIZED TRANSMISSION OPPORTUNITY (S-TXOP)” [Ref No. AD8034-US].

### TECHNICAL FIELD

Embodiments pertain to wireless communications. Some embodiments relate to wireless networks including wireless local area networks (WLANS) including those operating in accordance with the IEEE 802.11 standards. Some embodiments relate to wireless time-sensitive networks (TSN) and wireless time-sensitive networking.

### BACKGROUND

Emerging time-sensitive (TS) applications represent new markets for wireless networks. Industrial automation, robotics, AR/VR and HMIs (Human-Machine Interface) are example applications. IEEE TSN (Time-Sensitive Networking) standards are being extended over Wi-Fi and 5G to provide the determinism required by many applications in industrial, enterprise and consumer domains. TSN features over Wi-Fi will need more efficient scheduling capabilities from the 802.11 MAC. Although IEEE 802.11ax has introduced triggered-based OFDMA operation, the overhead involved in the basic trigger-based data exchange within a TXOP is high, especially for small packet sizes. Many time-sensitive applications involve isochronous (cyclic) transmission of small packets (typically a few bytes) within very short cycles with high reliability. Thus what is needed are communication techniques suitable for time-sensitive applications that require lower overhead and are compatible with legacy network communications (i.e., IEEE 802.11ax and previous versions of the 802.11 standard).

### BRIEF DESCRIPTION OF THE DRAWINGS

FIG. 1A depicts a diagram illustrating an example network, in accordance with some embodiments.

FIG. 1B depicts an illustrative enhanced wireless time sensitive networking (WTSN) medium access control/physical layer (MAC/PHY) configuration for a WTSN device, in accordance with some embodiments.

FIG. 2 depicts an illustrative timing diagram of an enhanced WTSN time synchronization, in accordance with some embodiments.

FIG. 3A depicts an illustrative control channel access sequence, in accordance with some embodiments.

FIG. 3B depicts an illustrative combined channel access sequence, in accordance with some embodiments.

FIG. 3C depicts an illustrative on-demand channel access sequence, in accordance with some embodiments.

FIG. 4A illustrates an synchronous transmission opportunity (S-TXOP), in accordance with some embodiments.

FIG. 4B illustrates S-TXOP Initial Configuration and Resource Allocation signaling, in accordance with some embodiments.

FIG. 4C illustrates an S-TXOP DL Slot Configuration, in accordance with some embodiments.

FIG. 4D illustrates an S-TXOP UL Slot Configuration, in accordance with some embodiments.

FIG. 5A illustrates an S-TXOP allocation update, in accordance with some embodiments.

FIG. 5B illustrates the signaling periodic and aperiodic schedule information associated with an allocation identifier (ID), in accordance with some embodiments.

FIG. 5C illustrates a format of allocation information field, in accordance with some embodiments.

FIG. 5D illustrates resource unit (RU) locations in an 80 MHz PPDU, in accordance with some embodiments.

FIG. 6 illustrates a wireless communication device, in accordance with some embodiments.

### DETAILED DESCRIPTION

The following description and the drawings sufficiently illustrate specific embodiments to enable those skilled in the art to practice them. Other embodiments may incorporate structural, logical, electrical, process, and other changes. Portions and features of some embodiments may be included in, or substituted for, those of other embodiments. Embodiments set forth in the claims encompass all available equivalents of those claims.

Embodiments disclosed herein utilize an synchronized transmission opportunity (S-TXOP) that allows very low overhead data transmission targeting isochronous traffic with strict latency bounds. The S-TXOP allows PPDU lengths to be reduced by getting rid of legacy parts in a preamble as much as possible and by compressing signaling for allocating resources in UL (e.g., information in Basic TF) or DL direction (e.g., information in EHT-SIG-B) by providing an index to a known allocation rather than including the entire allocation within the PPDU. Embodiments disclosed herein provide for resource allocation and resource update for S-TXOP. Some embodiments disclosed herein provide for resource allocation and resource update based on network conditions. These embodiments, as well as others, are described in more detail below.

Some embodiments disclosed herein provide mechanisms to signal configuration and resource allocation for communicating with S-TXOPs.

To communicate with a plurality of non-AP stations (STAs) within synchronized transmission opportunities (S-TXOPs), an access point station (AP) performs an initial management frame exchange with the STAs. During the initial management frame exchange, one or more sets of semi-static allocation parameters are signalling to the STAs. Each set of semi-static allocation parameters is associated with an allocation index (IDx). The AP may communicate data with the STAs during S-TXOPs that follow the initial management frame exchange. Each of the S-TXOPs may include an S-TXOP trigger. The S-TXOP trigger may be encoded to include one of the allocation indices to indicate a known allocation for use during the associated S-TXOP when a set of the predetermined semi-static allocation parameters are to be used. The S-TXOP trigger may be encoded to include full allocation information to indicate a new allocation for use during the associated S-TXOP when the predetermined semi-static allocation parameters are not used. These embodiments are described in more detail below.

Example embodiments described herein provide certain systems, methods, and devices for enhanced time sensitive network coordination for wireless communications. The following description and the drawings sufficiently illustrate specific embodiments to enable those skilled in the art to practice them. Other embodiments may incorporate structural, logical, electrical, process, and other changes. Portions and features of some embodiments may be included in, or substituted for, those of other embodiments. Embodiments set forth in the claims encompass all available equivalents of those claims.

Reliable and deterministic communications between devices may be required in some circumstances. One example may be time sensitive networking (TSN). TSN applications may require very low and bounded transmission latency and high availability and may include a mix of traffic patterns and requirements from synchronous data flows (e.g., from sensors to a controller in a closed loop control system), to asynchronous events (e.g., a sensor detecting an anomaly in a monitored process and sending a report right away), to video streaming for remote asset monitoring and background IT/office traffic. Many TSN applications also may require communication between devices with ultra-low latency (e.g., on the order of tens of microseconds).

Autonomous systems, smart factories, professional audio/video, and mobile virtual reality are examples of time sensitive applications that may require low and deterministic latency with high reliability. Deterministic latency/reliability may be difficult to achieve with existing Wi-Fi standards (e.g., the IEEE 802.11 family of standards), which may focus on improving peak user throughput (e.g., the IEEE 802.11ac standard) and efficiency (e.g., the IEEE 802.11ax standard). Extending the application of Wi-Fi beyond consumer-grade applications to provide wireless TSN (WTSN) performance presents an opportunity to apply Wi-Fi to Internet of things (IOT), and new consumer markets (e.g., wireless virtual reality). The non-deterministic nature of the IEEE 802.11 medium access control (MAC) layer in an unlicensed spectrum may impose challenges to expanding the application of Wi-Fi in this manner, especially when trying to guarantee reliability in comparison to Ethernet TSN applications.

It may be desirable to enable time-synchronized and scheduled MAC layer communications to facilitate time sensitive transmissions over Wi-Fi. The MAC may benefit from a more flexible control/management mechanism to adapt scheduling and/or transmission parameters (e.g., adapt a modulation and coding scheme and increase power) to control latency and to increase reliability. For example, changes in a wireless channel, such as interference or fading, may trigger retransmissions, which may impact the latency for time sensitive data due to increased channel throughput. An access point (AP) may update station (STA) transmission parameters to increase reliability (e.g., increase transmission power), which may require a transmission schedule update. An AP may also reduce a number of STAs that share a given service period to provide more capacity for retransmissions within a maximum required latency. Another example may include high-priority data (e.g., random alarms/events in an industrial control system), which may need to be reported with minimal latency, but cannot be scheduled a priori. Although regular beacons may be used to communicate scheduling and other control/management updates, it may be desirable to have a more deterministic and flexible control mechanism in future Wi-Fi networks that may enable faster management/scheduling of a wireless channel to facilitate time sensitive applications with high reliability and efficiency.

It may also be desirable to ensure that devices in a network or extended service set (ESS) receive schedule updates and maintain a synchronized schedule. Once a time sensitive transmission schedule is updated, all devices may need to receive the updated schedule before the schedule may become applicable, otherwise the updated schedule may not be reliable (e.g., not all devices may properly follow the schedule). To meet the requirements of time sensitive traffic, it may be desirable to ensure that all relevant devices comply with schedule updates regardless of active and sleep states of the devices.

To enable synchronization and scheduling, control/management frames may be used. Control/management frames may share a channel with data frames. It may be desirable, however, to have a dedicated channel for control/management frames that may be separate from a data channel. In addition, it may be desirable to have mechanisms to enable dynamic control/management actions using controlled latency and high reliability. Something other than beacon transmissions by themselves may be beneficial to enable dynamic and fast updates to operations required to maintain a quality of service for time sensitive applications.

To support such WTSN operations, it may be beneficial to redesign the MAC layer and physical layer (PHY) to improve efficiency and performance without needing to consider legacy behaviors or support backward compatibility while being able to coexist with legacy devices. A greenfield mode may refer to a device that assumes that there are no legacy (e.g., operating under previous protocol rules) stations (STAs) using the same channel. Thus, a device operating with a greenfield mode may operate under an assumption that all other STAs follow the same (e.g., newest) protocols, and that no legacy STAs are competing for the same channel access. In some embodiments, an STA operating with a greenfield mode may at least assume that any legacy STAs that may exist may be managed to operate in a separate channel and/or time. However, operations with multiple access points (APs) may experience interference, latency, and/or other performance issues. For example, APs may not all be aware of what other APs and STAs may be doing. Therefore, it may be desirable to define a greenfield Wi-Fi operation in a 6-7 GHz band or another frequency band, and thereby enable a time synchronized scheduled access mode for multiple APs in the 6-7 GHz band or other existing frequency bands (e.g., 2.4 GHz, 5 GHz) of future Wi-Fi generations.

The design of a greenfield air interface may be governed by significant reliability and latency constraints imposed by WTSN operations. It may therefore be desirable to efficiently design MAC and PHY communications to support WTSN applications. Legacy MAC/PHY operations may be asynchronous and may apply contention-based channel access and may require significant overhead for backward compatibility that may be important for devices to coexist in unlicensed frequency bands. Such legacy MAC/PHY operations may be too inefficient to support time sensitive applications, especially as such traffic increases, but they may still be used for non-time sensitive data or control traffic (e.g. in a legacy control channel).

While contention-free channel access mechanisms exist (e.g., point coordination function, hybrid coordination function controlled channel access), such mechanisms may lack the predictability required to support WTSN operations, as the mechanisms may be stacked on a distributed coordination function and may use polling operations with significant overhead and other inefficient steps.

Device synchronization may use transmissions with significant overhead. For example, PHY headers may be included in some or all transmissions between devices. For example, data frames and acknowledgement (ACK) frames may use legacy preambles that make the frames longer, reducing the number of transmissions that may be accomplished during a transmission opportunity (TXOP). Synchronization that occurs up front (e.g., at the start of a TXOP) may allow for reduced overhead in subsequent transmissions, and therefore may reduce the resources required for some transmissions and may allow for more throughput and lower latency in a channel.

Example embodiments of the present disclosure relate to systems, methods, and devices for enhanced time sensitive networking for wireless communications.

In some embodiments, time sensitive control and data channel operations may be enabled for IEEE 802.11 standards, including for future generations of IEEE 802.11 standards (e.g., beyond IEEE 802.11ax, including 6-7 GHz communication bands, and/or in deployments in which it may be feasible to enable channel/band steering of an STA with time sensitive requirements, such as in managed private networks.

In some embodiments, control information may be updated (e.g., using scheduling) without interfering with time sensitive data, ensuring latency and reliability guarantees. For example, a time sensitive data transmission may be needed, and control information such as transmission schedules may also need to be updated to facilitate subsequent transmission. The control information updates may be sent and implemented without interfering with the time sensitive data transmissions.

In some embodiments, a time sensitive control channel (TSCCH) may be defined by combining two approaches: a periodic approach and an on-demand approach. The period approach may include predefined control slots. In the on-demand approach, an AP may define control slots as needed. A TSCCH access mechanism may use contention-based or time synchronized scheduled access procedures. Also, a wake-up signal may be used to allow delivery of time sensitive control/management information to STAs across a network, reducing latency and allowing power save modes for the STAs.

In some embodiments, a TSCCH may be in a different physical/logical channel from a data transmission. For example, a data transmission may use a data channel (e.g., in a 6-7 GHz band) while TSCCH may use separate control channel in another band (e.g., 2.4 GHz or 5 GHz).

In some embodiments, use of a TSCCH operation and access mechanism may allow improved flexibility and more deterministic opportunities for an AP to provide timely updates (e.g., schedules and control parameters) needed to manage latency and reliability, which may be beneficial in supporting time sensitive applications.

In some embodiments, a greenfield operation deployed in existing or new frequency bands (e.g., 6-7 GHz) and other managed networks may facilitate improved management of Wi-Fi networks operating in scheduled modes with time sensitive operations.

In some embodiments, it may be assumed that a Wi-Fi network may be managed and that there are no unmanaged nearby Wi-Fi STAs or networks. This assumption may be reasonable for time sensitive applications.

In some embodiments, it may be assumed that APs and STAs may synchronize their clocks to a master reference time. For example, STAs may synchronize to beacons and/or may use time synchronization protocols (e.g., as defined by the IEEE 802.1AS standard or other synchronization capabilities defined in the 802.11 standard).

In one or embodiments, it may be assumed that an AP may define a time-synchronized scheduled mode. In some embodiments, a greenfield mode may apply to a 6-7 GHz frequency band, and the greenfield mode may apply to other bands (e.g., 2.4 GHz, 5 GHz) where support for legacy devices may not be required (e.g., in some private networks). A greenfield mode may be applied according to the following principles.

In some embodiments, a fully synchronized and scheduled operation may be defined for a self-contained/synchronized transmission opportunity (S-TXOP) that may include a series of both uplink and downlink transmissions. During an S-TXOP, an AP may maintain control of a medium and may schedule access across predefined deterministic time boundaries. The use of an S-TXOP may maximize an amount of TSN traffic served while providing latency and reliability guarantees that support time sensitive operations with high efficiency.

In some embodiments, communication overheads related to synchronization, channel measurement and feedback, scheduling, and resource allocation may be intelligently packed at the beginning of an S-TXOP and may allow subsequent data transmissions to be extremely lightweight with minimal overhead. For example, up-front synchronization may allow for devices to be configured so that the devices do not need as much information as is currently provided in legacy headers. Instead, headers may be shorter because an S-TXOP has been coordinated among devices. The reduced overhead may allow for more TSN traffic to be served while providing sufficient latency and reliability of transmissions.

In some embodiments, there may be flexibility to define deterministic communication boundaries within an S-TXOP to accommodate applications requiring latency bounds in a sub-millisecond range, or other tight time ranges, for example.

In some embodiments, a multi-band framework may be leveraged to allow backward compatibility and coexistence with legacy Wi-Fi applications. A new greenfield mode as defined herein may be used for data communications, and minimal control may be required to sustain target latency, reliability, and throughput performance. Legacy modes and bands may be used to perform basic/long-term control and management tasks (e.g., non-time sensitive tasks) as well as time sensitive tasks.

In some embodiments, to reduce overhead for coexistence, a first transmission in an S-TXOP may include a legacy preamble to enable coexistence with legacy devices.

In some embodiments, enhanced time sensitive networking may improve performance over some existing wireless communications. For example, efficiency and latency may be improved, and the enhanced time sensitive networking may support a larger number of STAs for a given wireless resource while meeting latency bounds for TSN applications. (e.g., augmented virtual reality, industrial control, and autonomous systems). Enhanced time sensitive networking may allow coexistence with legacy Wi-Fi operations by leveraging multi-band devices. Coexistence across networks operating in a greenfield mode as defined herein may be allowed by having better management and coordination across basic service sets (BSSs), which may be facilitated by higher layer management/coordination protocols.

In some embodiments, a number of assumptions may be used for the greenfield mode of enhanced time sensitive networking. In some embodiments, WTSN STAs may be multi-band devices in which the MAC/PHY may operate in a different band (e.g., 6-7 GHz) than the band of a legacy STA, which may operate in 2.4 GHz or 5 GHz bands.

In some embodiments, a fully managed Wi-Fi deployment scenario in which other radio technology (e.g., legacy Wi-Fi or cellular) may not be expected to operate in a same band where a WTSN STA may be operating. In some embodiments, the enhanced time sensitive networking may be used in an indoor operating environment with relatively low mobility.

In some embodiments, a packet belonging to a TSN-grade application when queued at a WTSN STA may be dropped at a transmitter side if the packet does not get into air within a certain latency bound time.

The above descriptions are for purposes of illustration and are not meant to be limiting. Numerous other examples, configurations, processes, etc., may exist, some of which are described in detail below. Example embodiments will now be described with reference to the accompanying figures.

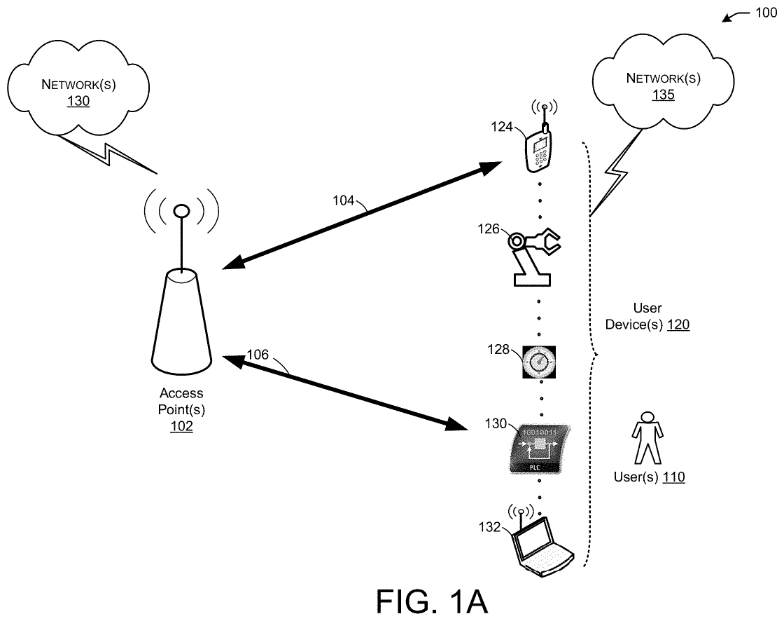

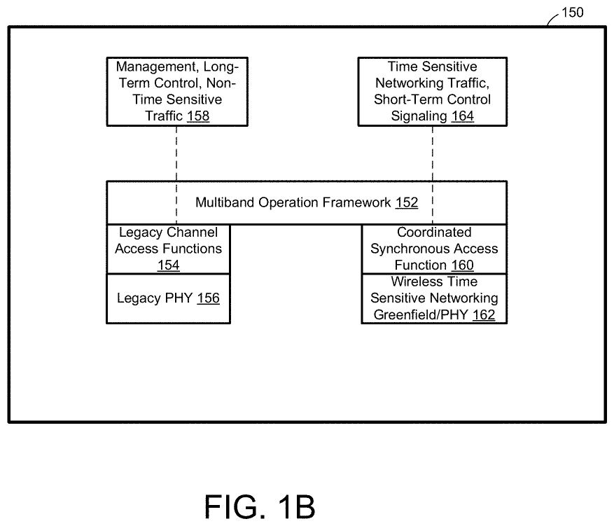

FIG. 1A is a diagram illustrating an example network environment, in accordance with some embodiments. Wireless network 100 may include one or more user devices 120 and one or more access point(s) (APs) 102, which may communicate in accordance with and compliant with various communication standards and protocols, such as, Wi-Fi, TSN, Wireless USB, P2P, Bluetooth, NFC, or any other communication standard. The user device(s) 120 may be mobile devices that are non-stationary (e.g., not having fixed locations) or may be stationary devices.

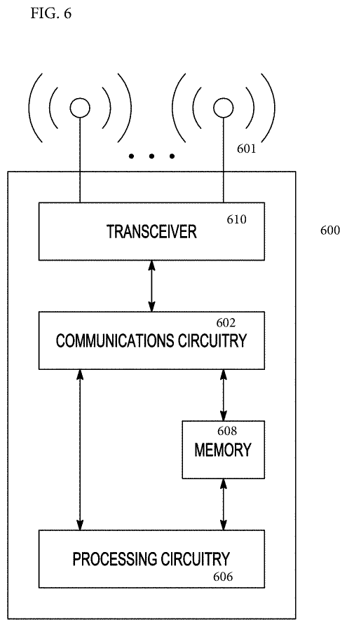

In some embodiments, the user devices 120 and AP 102 may include one or more computer systems similar to that of the functional diagram of FIG. 6. One or more illustrative user device(s) 120 and/or AP 102 may be operable by one or more user(s) 108. It should be noted that any addressable unit may be a station (STA). An STA may take on multiple distinct characteristics, each of which shape its function. For example, a single addressable unit might simultaneously be a portable STA, a quality-of-service (QoS) STA, a dependent STA, and a hidden STA. The one or more illustrative user device(s) 120 and the AP(s) 102 may be STAs. The one or more illustrative user device(s) 120 and/or AP 102 may operate as a personal basic service set (PBSS) control point/access point (PCP/AP). The user device(s) 120 (e.g., 124, 126, or 128) and/or AP 102 may include any suitable processor-driven device including, but not limited to, a mobile device or a non-mobile, e.g., a static, device. For example, user device(s) 120 and/or AP 102 may include, a user equipment (UE), a station (STA), an access point (AP), a software enabled AP (SoftAP), a personal computer (PC), a wearable wireless device (e.g., bracelet, watch, glasses, ring, etc.), a desktop computer, a mobile computer, a laptop computer, an Ultrabook™ computer, a notebook computer, a tablet computer, a server computer, a handheld computer, a handheld device, an internet of things (IoT) device, a sensor device, a robotic device, an actuator, a robotic arm, an industrial robotic device, a programmable logic controller (PLC), a safety controller and monitoring device, a PDA device, a handheld PDA device, an on-board device, an off-board device, a hybrid device (e.g., combining cellular phone functionalities with PDA device functionalities), a consumer device, a vehicular device, a non-vehicular device, a mobile or portable device, a non-mobile or non-portable device, a mobile phone, a cellular telephone, a PCS device, a PDA device which incorporates a wireless communication device, a mobile or portable GPS device, a DVB device, a relatively small computing device, a non-desktop computer, a “carry small live large” (CSLL) device, an ultra mobile device (UMD), an ultra mobile PC (UMPC), a mobile internet device (MID), an “origami” device or computing device, a device that supports dynamically composable computing (DCC), a context-aware device, a video device, an audio device, an A/V device, a set-top-box (STB), a blu-ray disc (BD) player, a BD recorder, a digital video disc (DVD) player, a high definition (HD) DVD player, a DVD recorder, a HD DVD recorder, a personal video recorder (PVR), a broadcast HD receiver, a video source, an audio source, a video sink, an audio sink, a stereo tuner, a broadcast radio receiver, a flat panel display, a personal media player (PMP), a digital video camera (DVC), a digital audio player, a speaker, an audio receiver, an audio amplifier, a gaming device, a data source, a data sink, a digital still camera (DSC), a media player, a smartphone, a television, a music player, or the like. Other devices, including smart devices such as lamps, climate control, car components, household components, appliances, etc. may also be included in this list.

Any of the user device(s) 120 (e.g., user devices 124, 126, 128, 130, and 132), and AP 102 may be configured to communicate with each other via one or more communications networks 135 and/or 140 wirelessly or wired. The user device(s) 120 may also communicate peer-to-peer or directly with each other with or without the AP 102. Any of the communications networks 135 and/or 140 may include, but not limited to, any one of a combination of different types of suitable communications networks such as, for example, broadcasting networks, cable networks, public networks (e.g., the Internet), private networks, wireless networks, cellular networks, or any other suitable private and/or public networks. Further, any of the communications networks 135 and/or 140 may have any suitable communication range associated therewith and may include, for example, global networks (e.g., the Internet), metropolitan area networks (MANs), wide area networks (WANs), local area networks (LANs), or personal area networks (PANs). In addition, any of the communications networks 135 and/or 140 may include any type of medium over which network traffic may be carried including, but not limited to, coaxial cable, twisted-pair wire, optical fiber, a hybrid fiber coaxial (HFC) medium, microwave terrestrial transceivers, radio frequency communication mediums, white space communication mediums, ultra-high frequency communication mediums, satellite communication mediums, or any combination thereof.

Any of the user device(s) 120 (e.g., user devices 124, 126, 128, 130, and 132) and AP 102 may include one or more communications antennas. The one or more communications antennas may be any suitable type of antennas corresponding to the communications protocols used by the user device(s) 120 (e.g., user devices 124, 126, 128, 130, and 132), and AP 102. Some non-limiting examples of suitable communications antennas include Wi-Fi antennas, Institute of Electrical and Electronics Engineers (IEEE) 802.11 family of standards compatible antennas, directional antennas, non-directional antennas, dipole antennas, folded dipole antennas, patch antennas, multiple-input multiple-output (MIMO) antennas, omnidirectional antennas, quasi-omnidirectional antennas, or the like. The one or more communications antennas may be communicatively coupled to a radio component to transmit and/or receive signals, such as communications signals to and/or from the user devices 120 and/or AP 102.

Any of the user device(s) 120 (e.g., user devices 124, 126, 128, 130, and 132), and AP 102 may be configured to perform directional transmission and/or directional reception in conjunction with wirelessly communicating in a wireless network. Any of the user device(s) 120 (e.g., user devices 124, 126, 128, 130, and 132), and AP 102 may be configured to perform such directional transmission and/or reception using a set of multiple antenna arrays (e.g., DMG antenna arrays or the like). Each of the multiple antenna arrays may be used for transmission and/or reception in a particular respective direction or range of directions. Any of the user device(s) 120 (e.g., user devices 124, 126, 128, 130, and 132), and AP 102 may be configured to perform any given directional transmission towards one or more defined transmit sectors. Any of the user device(s) 120 (e.g., user devices 124, 126, 128, 130, and 132), and AP 102 may be configured to perform any given directional reception from one or more defined receive sectors.

MIMO beamforming in a wireless network may be accomplished using RF beamforming and/or digital beamforming. In some embodiments, in performing a given MIMO transmission, user devices 120 and/or AP 102 may be configured to use all or a subset of its one or more communications antennas to perform MIMO beamforming.

Any of the user devices 120 (e.g., user devices 124, 126, 128, 130, and 132), and AP 102 may include any suitable radio and/or transceiver for transmitting and/or receiving radio frequency (RF) signals in the bandwidth and/or channels corresponding to the communications protocols utilized by any of the user device(s) 120 and AP 102 to communicate with each other. The radio components may include hardware and/or software to modulate and/or demodulate communications signals according to pre-established transmission protocols. The radio components may further have hardware and/or software instructions to communicate via one or more communication standards and protocols, such as, Wi-Fi, TSN, Wireless USB, Wi-Fi P2P, Bluetooth, NFC, or any other communication standard. In certain example embodiments, the radio component, in cooperation with the communications antennas, may be configured to communicate via 2.4 GHz channels (e.g. 802.11b, 802.11g, 802.11n, 802.11ax), 5 GHz channels (e.g. 802.11n, 802.11ac, 802.11ax), or 60 GHZ channels (e.g. 802.11ad). In some embodiments, non-Wi-Fi protocols may be used for communications between devices, such as Bluetooth, dedicated short-range communication (DSRC), Ultra-High Frequency (UHF) (e.g. IEEE 802.11af, IEEE 802.22), white band frequency (e.g., white spaces), or other packetized radio communications. The radio component may include any known receiver and baseband suitable for communicating via the communications protocols. The radio component may further include a low noise amplifier (LNA), additional signal amplifiers, an analog-to-digital (A/D) converter, one or more buffers, and digital baseband.

When an AP (e.g., AP 102) establishes communication with one or more user devices 120 (e.g., user devices 124, 126, 128, 130 and/or 132), the AP 102 may communicate in a downlink direction and the user devices 120 may communicate with the AP 102 in an uplink direction by sending frames in either direction. The user devices 120 may also communicate peer-to-peer or directly with each other with or without the AP 102. The data frames may be preceded by one or more preambles that may be part of one or more headers. These preambles may be used to allow a device (e.g., AP 102 and/or user devices 120) to detect a new incoming data frame from another device. A preamble may be a signal used in network communications to synchronize transmission timing between two or more devices (e.g., between the APs and user devices).

In some embodiments, and with reference to FIG. 1A, an AP 102 may communicate with user devices 120. The user devices 120 may include one or more wireless devices (e.g., user devices 124, 132) and one or more wireless TSN devices (e.g., user devices 126 128, 130). The user devices may access a channel in accordance with medium access control (MAC) protocol rules or any other access rules (e.g., Wi-Fi, Bluetooth, NFC, etc.). It should be noted that reserving a dedicated TSN channel and controlling access to it may also be applicable to cellular systems/3GPP networks, such as LTE, 5G, or any other wireless networks. The wireless TSN devices may also access a channel according to the same or modified protocol rules. However, the AP 102 may dedicate certain channels or sub-channels for TSN applications that may be needed by the one or more wireless TSN devices (e.g., user devices 126, 128, and 130), and may allocate other channels or sub-channels for the non-TSN devices (e.g., user devices 124 and 132).

In some embodiments, AP 102 may also define one or more access rules associated with the dedicated channels. A channel may be dedicated for TSN transmissions, TSN applications, and TSN devices. For example, user device 126 may access a dedicated TSN channel for TSN transmissions. TSN transmissions may include transmissions that have very low transmission latency and high availability requirements. Further, the TSN transmissions may include synchronous TSN data flows between sensors, actuators, controllers, robots, in a closed loop control system. The TSN transmissions require reliable and deterministic communications. A channel may be accessed by the user device 126 for a number of TSN message flows and is not limited to only one TSN message flow. The TSN message flows may depend on the type of application messages that are being transmitted between the AP 102 and the user device 126.

In some embodiments, while frequency planning and channel management may be used to allow AP 102 to collaborate with neighboring APs (not shown) to operate in different channels, the efficiency and feasibility of reserving multiple non-overlapping data channels for time sensitive applications may be improved. It may be desirable to limit the amount of resources reserved for time sensitive data through efficient channel reuse. If multiple devices (e.g., user devices 124, 126, 128, 130, 132) share a dedicated channel for time sensitive data transmissions, interference among multiple transmissions may be reduced with enhanced coordination between the devices and one or more APs (e.g., AP 102). For example, overlap and interference of control transmissions (e.g., a beacon), downlink data transmissions, and uplink data transmissions may be reduced with enhanced coordination. Such enhanced coordination for multiple APs may enable more efficient channel usage while also meeting latency and reliability requirements of time sensitive applications. For example, if control transmissions are not received and interpreted properly, time sensitive operations may not be scheduled properly, and/or may interfere with other transmissions, possibly causing operational errors.

In some embodiments, AP 102 may include WTSN controller functionality (e.g., a wireless TSN controller capability), which may facilitate enhanced coordination among multiple devices (e.g., user devices 124, 126, 128, 130, 132). AP 102 may be responsible for configuring and scheduling time sensitive control and data operations across the devices. A wireless TSN (WTSN) management protocol may be used to facilitate enhanced coordination between the devices, which may be referred to as WTSN management clients in such context. AP 102 may enable device admission control (e.g., control over admitting devices to a WTSN), joint scheduling, network measurements, and other operations.

In some embodiments, AP 102's use of WTSN controller functionality may facilitate AP synchronization and alignment for control and data transmissions to ensure latency with high reliability for time sensitive applications on a shared time sensitive data channel, while enabling coexistence with non-time sensitive traffic in the same network.

In some embodiments, AP 102 and its WTSN coordination may be adopted in future Wi-Fi standards for new bands (e.g., 6-7 GHz), in which additional requirements of time synchronization and scheduled operations may be used. Such application of the WTSN controller functionality may be used in managed Wi-Fi deployments (e.g., enterprise, industrial, managed home networks, etc.) in which time sensitive traffic may be steered to a dedicated channel in existing bands as well as new bands.

In some embodiments, it may be assumed that a Wi-Fi network may be managed, and that there are no unmanaged Wi-Fi STAs/networks nearby.

In some embodiments, it may be assumed that APs and STAs may synchronize their clocks to a master reference times (e.g., STAs may synchronize to beacons and/or may use time synchronization protocols as defined in the IEEE 802.1AS standard).

In some embodiments, it may be assumed that APs and STAs may operate according to a time synchronized scheduled mode that may also apply to new frequency bands (e.g., 6-7 GHz), for which new access protocols and requirements also may be proposed.

In some embodiments, a WTSN domain may be defined as a set of APs (e.g., AP 102) and STAs (e.g., user devices 124, 126, 128, 130, and 132) that may share dedicated wireless resources, and therefore may need to operate in close coordination, at a level of control and time sensitive data scheduling, to ensure latency and reliability guarantees. Different APs in the same network may form different WTSN domains.

In some embodiments, the WTSN management protocol may be executed over a wired (e.g., Ethernet) TSN infrastructure that may provide TSN grade time synchronization accuracy and latency guarantees. The WTSN management protocol may also be executed using wireless links (e.g., a wireless backhaul, which may include Wi-Fi or WiGig links through one or multiple hops). An Ethernet TSN interface may be replaced by a wireless interface (e.g., and 802.11 MAC and/or physical layer PHY). An operation of a second wireless interface may also be managed by AP 102 to avoid interference with an interface used for communication with time sensitive user STAs (e.g., user devices 126, 128, and 130).

In some embodiments, AP 102 may perform admission control and scheduling tasks. To complete an association procedure for an STA with time sensitive data streams (e.g., user device 130), the STA may request admission from AP 102. AP 102 may define which APs may be in a WTSN domain and may determine the admission of new time sensitive data streams based on, for example, available resources and user requirements. AP 102 may create and/or update a transmission schedule that may include time sensitive operations and/or non-time sensitive operations, and the schedule may be provided to admitted user devices. AP 102 may be responsible for executing the schedule according to time sensitive protocols defined, for example, at 802.11 MAC/PHY layers.

In some embodiments, AP 102 may perform transmission schedule updates. AP 102 may update a transmission schedule for time sensitive data and may send transmission schedule updates to STAs and/or other APs during network operation. A transmission schedule update may be triggered by changes in wireless channel conditions at different APs and/or STAs within a common WTSN domain. The condition changes may include increased interference, new user traffic requests, and other network and/or operational changes that may affect a WTSN domain.

In some embodiments, AP 102 may collect measurement data from other devices in a WTSN domain. The measurement data may be collected from time sensitive and/or non-time sensitive devices. AP 102 may maintain detailed network statistics, for example, related to latency, packet error rates, retransmissions, channel access delay, etc. The network statistics may be collected via measurement reports sent from STAs. AP 102 may use network statistics to proactively manage wireless channel usage to allow for a target latency requirement to be satisfied. For example, measurements may be used to determine potential channel congestion and to trigger a change from a joint transmission schedule mode to a mode in which APs may allocate a same slot to multiple non-interfering STAs that may be leveraging spatial reuse capabilities.

It is understood that the above descriptions are for purposes of illustration and are not meant to be limiting.

FIG. 1B depicts an illustrative enhanced WTSN MAC/PHY configuration for a WTSN device 150, in accordance with some embodiments.

In some embodiments, the WTSN device 150 may include a multiband operation framework 152, legacy channel access functions 154, legacy PHY 156, management, long-term control, and non-time sensitive traffic 158, coordinated synchronous access function (CSAF) 160, WTSN greenfield/PHY 162, and TSN traffic, short-term control signaling 164.

In some embodiments, the multiband operation framework 152 may allow WTSN device 150 to perform multiband operations. For example, some operations may be performed in one frequency band, while other operations may be performed in another frequency band. One frequency band may include a control channel, and another frequency band may include separate data channels.

In some embodiments, to provide for both WTSN and non-TSN operations, the WTSN device 150 may include a link for management, long-term control, and non-time sensitive traffic 158, and a link for TSN traffic and short-term control signaling 164. To support the management, long-term control, and non-time sensitive traffic 158, WTSN device 150 may include legacy channel access functions 154. Legacy channel access functions 154 may include a distributed coordination function (DCF), hybrid coordination function controlled channel access (HCF), and other channel access functions. The management, long-term control, and non-time sensitive traffic 158 may also be supported by a legacy PHY 156 (e.g., on a 2.4 GHz or 5 GHz frequency). Long-term control may include beacon transmissions, network association, security procedures, and other control traffic. Short-term control may include radio synchronization (e.g., time-frequency synchronization), scheduling, channel feedback, and other control traffic.

In some embodiments, to support the TSN traffic, short-term control signaling 164, WTSN device 150 include the CSAF 160 and the WTSN greenfield/PHY 162. The CSAF 160 may use a central coordinator at WTSN device 150 (e.g., AP 102 of FIG. 1A) to maintain a MAC/PHY level synchronization between the WTSN device 150 and non-AP STAs during an S-TXOP. The WTSN device 150 may control access to wireless media in a scheduled fashion in time, frequency, and spatial dimensions. With an infrastructure for a basic service set (BSS) for WTSN, during an S-TXOP, all WTSN STAs may need to adhere to the MAC/PHY synchronization at all times.

In some embodiments, when WTSN STAs (e.g., user device 126, user device 128, user device 130 of FIG. 1A) are not standalone devices, WTSN-capable devices may associate with a network using a legacy link (e.g., legacy channel access functions 154, legacy PHY 156, and management, long-term control, non-time sensitive traffic 158 of FIG. 1B). During association, a WTSN STA may indicate its capability and interest to join a WTSN operation mode. Through the legacy link, a multiband AP (e.g., AP 102 of FIG. 1A) may instruct the WTSN-capable STA to configure the WTSN STA's MAC/PHY on designated band. The WTSN MAC in the WTSN STA may achieve MAC/PHY synchronization and successfully read initial control and synchronization information in a synchronization and configuration frame (SCF) received from the AP in a WTSN band. Through the legacy link, the AP and STA may complete the association process by exchanging management frames. This process may be referred to as associating or establishing a channel/connection with a device.

In some embodiments, some long-term parameters and control signals related to a WTSN MAC/PHY operation may be conveyed from a WTSN AP to WTSN non-AP STAs through the legacy link.

In some embodiments, the legacy link may also be used for admission control and/or inter-BSS coordination, and the multiband operation framework 152 may be used to direct TSN traffic (e.g., TSN traffic, short-term control signaling 164) to the WTSN MAC/PHY (e.g., WTSN Greenfield/PHY 162). The WTSN MAC/PHY may provide functionality to support ultra-low and near-deterministic packet latency (e.g., one millisecond or less) with virtually no jitter in a controlled environment. Latency may be measured from a time when a logical link control (LLC) MAC service data unit (MDSU) enters a MAC sublayer at a transmitter to a time when the MDSU is successfully delivered from the MAC sublayer to an LLC sublayer on a receiver.

In some embodiments, WTSN operations may be facilitated by a synchronous and coordinated MAC/PHY operation during an S-TXOP between a WTSN AP and one or more non-AP WTSN STAs in a BSS infrastructure.

It is understood that the above descriptions are for purposes of illustration and are not meant to be limiting.

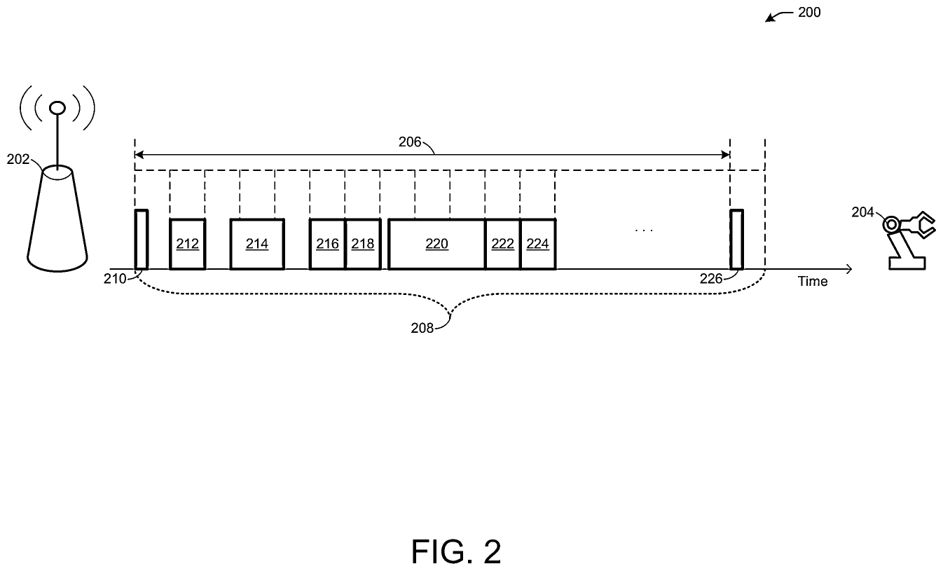

FIG. 2 depicts an illustrative timing diagram 200 of an enhanced WTSN time synchronization, in accordance with some embodiments. Referring to FIG. 2, there is shown uplink and downlink data frame flows between AP 202 and a TSN device 204. For example, TSN device 204 may receive downlink data frames from AP 202 and may send uplink data frames to AP 202. In one embodiment, the WTSN time synchronization may be utilized for persistent scheduling for synchronous transmission from TSN device 204 to AP 202.

In some embodiments, during a beacon period 206 (e.g., 100× cycle time), AP 202 may transmit or receive during one or more service periods 208 that comprise the beacon period 206. For example, service periods 208 may span 1 millisecond or some other time during which one or more transmissions may be made. A cycle time is a parameter that may be configured based on a service and/or latency requirements of one or more applications. For example, an STA application may generate packets in a synchronous/periodic pattern (e.g., of 1 millisecond cycles), and packets generated at the beginning of a cycle may need to be delivered within the cycle.

In some embodiments, AP 202 may send a control frame, such as a beacon 210 during a service period 208 at the beginning of beacon period 206. During TXOP 212, TXOP 214, TXOP 216, TXOP 218, TXOP 220, TXOP 220, TXOP 222, and TXOP 224, AP 202 may send or receive frames to/from TSN device 204. At the conclusion of beacon period 206, a new beacon period may begin with AP 202 sending beacon 226. In some embodiments, the control frame may be a trigger frame. In these embodiments, the control frame may be used to initiate a sequence of multiple transmissions within a period that repeats, as further described herein.

In some embodiments, any of TXOP 212, TXOP 214, TXOP 216, TXOP 218, TXOP 220, TXOP 220, TXOP 222, and TXOP 224 may include restricted or unrestricted service periods, time sensitive service periods, or non-time sensitive service periods. TXOP 212, TXOP 214, TXOP 216, TXOP 218, TXOP 220, TXOP 220, TXOP 222, and TXOP 224 may comprise one or more service periods 208.

It is understood that the above descriptions are for purposes of illustration and are not meant to be limiting.

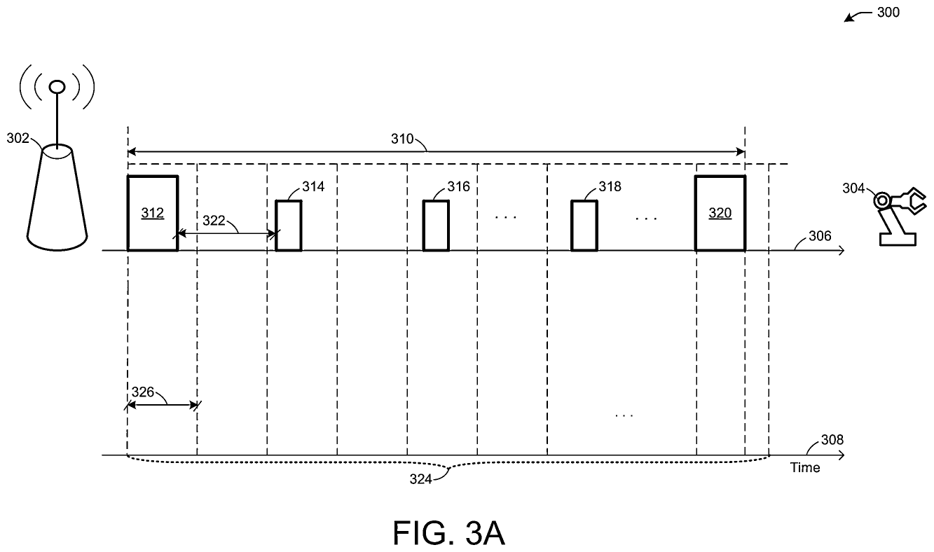

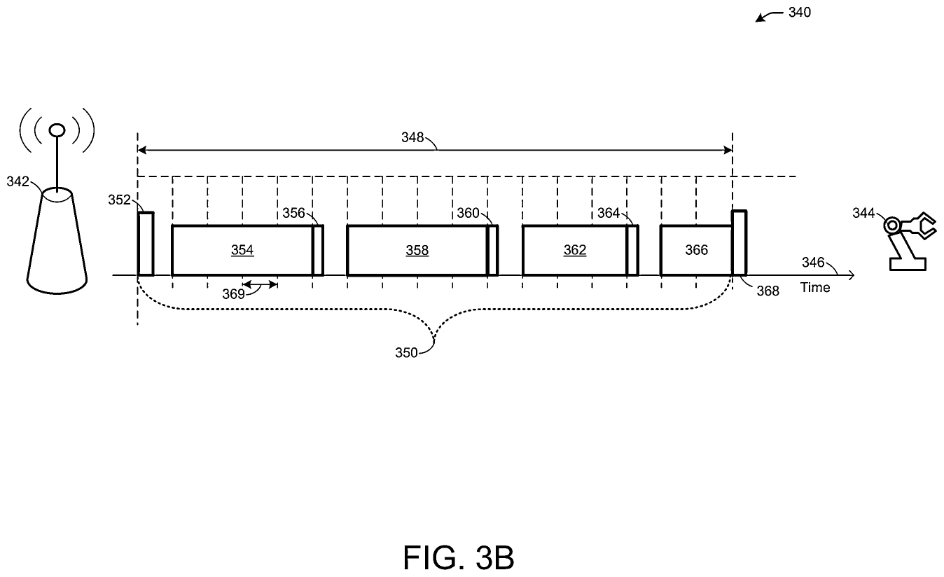

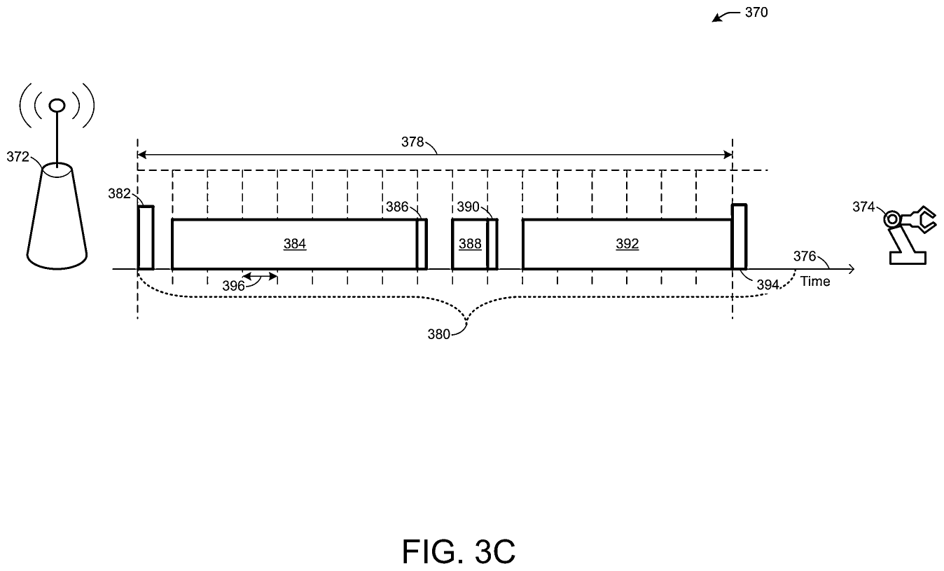

FIG. 3A depicts an illustrative control channel access sequence 300, in accordance with some embodiments. In some embodiments, AP 302 may be a WTSN device (e.g., WTSN device 150 of FIG. 1B) in communication with STA 304, which may be another WTSN device. AP 302 and STA 304 may use a TSCCH 306 and a TSDCH 308 to transmit both control/management frames and data frames.

In some embodiments, a beacon period 310 (e.g., 100× cycle time) may begin with AP 302 sending beacon 312. Later in beacon period 310, AP 302 may send short beacon 314, short beacon 316, short beacon 318, or any number of short beacons supported by the beacon period 310. At the end of beacon period 310, another beacon 320 may be sent by AP 302. Beacon 312, short beacon 314, short beacon 316, short beacon 318, and/or beacon 320 may provide control/management frames to STA 304 in TSCCH 306.

In some embodiments, TSCCH 306 and TSDCH 308 may be divided into cycles 324 which may span a cycle time 326 (e.g., 1 ms). Beacon 312, short beacon 314, short beacon 316, short beacon 318, and/or beacon 320 may not require an entire cycle 324.

In some embodiments, TSCCH 306 and TSDCH 308 may be logical channels defined within an existing or new physical channel/frequency band. TSCCH 306 may be defined within a primary channel, while TSDCH 308 may be defined in a secondary or dedicated TS channel, possibly in another frequency band. TSCCH 306 may be used for time sensitive access under control of AP 302. TSDCH 308 may be defined in an existing or new band (e.g., 6-7 GHz).

In some embodiments, configurations for TSCCH 306 and/or TSDCH 308 may be transmitted as information elements in beacon 312, short beacon 314, short beacon 316, short beacon 318, and/or beacon 320. The configurations may provide information identifying the corresponding physical channels used for TSCCH 306 and TSDCH 308.

In some embodiments, TSCCH 306 may be defined as periodic resources (e.g., time-frequency slots) for exchanging control frames. Defining a periodic interval for control frames may be important to enable time sensitive STAs (e.g., STA 304) to schedule time sensitive data and control actions without conflicts (e.g., conflicts with other devices).

In some embodiments, TSCCH 306 may be used to transmit regular beacons (e.g., beacon 312, beacon 320) and short beacons (e.g., short beacon 314, short beacon 316, short beacon 318), which may include a subset of information transmitted of regular beacons (e.g., an updated transmission schedule or bitmap of restricted time sensitive service periods). Short beacon transmissions may be scheduled in predefined intervals (e.g., fractions of beacon period 310). Other management frames may also be transmitted in TSCCH 306, such as association request/response frames, timing measurements, and channel feedback measurement frames.

In some embodiments, access to TSCCH 306 may use contention-based TSN sequence 300. Contention-based TSN sequence 300 may follow a legacy carrier-sense multiple access (CSMA)-based IEEE 802.11 MAC protocol. For example, when TSCCH 306 is defined as the operating/primary channel, AP 302 may contend for TSCCH 306 using enhanced distributed channel access (EDCA) to transmit beacon (e.g., beacon 312, beacon 320) and short beacons (e.g., short beacon 314, short beacon 316, short beacon 318) at predefined intervals. TSCCH control frames (e.g., beacon 312, short beacon 314, short beacon 316, short beacon 318, and/or beacon 320) may include information to support a time synchronized scheduled access in TSDCH 308. Such operation may enable time sensitive operations for legacy Wi-Fi systems in which TSCCH 306 may provide an anchor for TSDCH 308 (e.g., time synchronized and schedule) in one or more restricted channels and/or frequency bands.

In some embodiments, access to TSCCH 306 may use a time-synchronized access method. TSCCH 306 may be defined as periodic scheduled resources (e.g., time slots) for regular beacons (e.g., beacon 312, beacon 320) and short beacons (e.g., short beacon 314, short beacon 316, short beacon 318) using time-synchronized access. Access to time slots (e.g., cycles 324) may still be based on contention (e.g., CSMA) or may be scheduled. For example, slots may be reserved for beacons and short beacons, which may be transmitted periodically (e.g., every fifth slot). TSCCH 306 may also be aligned with TSDCH 308 timing. TSCCH time slots reserved for beacons and/or short beacons may be announced in regular beacons so that newly admitted STAs (e.g., STA 304) may discover TSCCH 306 parameters. All STAs may be required to adhere to time synchronization across channels and ensure TXOPs do not overlap with scheduled TSCCH slots. In addition, all STAs may be required to listen to TSCCH 306 during scheduled beacon/short beacon slots to make sure the STAs receive those beacons/short beacons. Such operation may provide a more deterministic operation as timing of each TSCCH 306 may be controlled and collisions may be avoided through efficient scheduling.

In some embodiments, remaining time of TSCCH slots (e.g., cycles 324) occupied by a beacon/short beacon may be used to exchange other control/management frames. In some embodiments, AP 302 may transmit unicast control/management frames to STA 304 using TSDCH 308 provided that the control/management frames do not interfere with time sensitive data.

It is understood that the aforementioned example is for purposes of illustration and not meant to be limiting.

FIG. 3B depicts an illustrative combined channel access sequence 340, in accordance with some embodiments. In some embodiments, AP 342 may be a WTSN device (e.g., WTSN device 150 of FIG. 1B) in communication with STA 344, which may be another WTSN device. AP 342 and STA 344 may use channel 346 to transmit both control/management frames and data frames.

In some embodiments, a beacon period 348 (e.g., 100× cycle time) having one or more cycles 350 may begin with AP 342 sending beacon 352. Later in beacon period 348, AP 342 and/or STA 344 may send one or more data frames 354. AP 342 may send short beacon 356. AP 342 and/or STA 344 may send one or more data frames 358. AP 342 may send short beacon 360. AP 342 and/or STA 344 may send one or more data frames 362. AP 342 may send short beacon 364. AP 342 and/or STA 344 may send one or more data frames 366. After beacon period 348 has concluded, AP 342 may send another beacon 368 to begin another beacon period. The beacons (e.g., beacon 352, short beacon 356, short beacon 360, short beacon 364, and beacon 368) may be sent in channel 346. The one or more data frames (e.g., one or more data frames 354, one or more data frames 358, one or more data frames 362, and one or more data frames 366) may be sent in the channel 346.

In some embodiments, channel 346 may be divided into cycles 350 which may span a cycle time 369 (e.g., 1 ms). Beacon 352, short beacon 356, short beacon 360, short beacon 364, and beacon 368 may not require an entire cycle 350. The one or more data frames (e.g., one or more data frames 354, one or more data frames 358, one or more data frames 362, and one or more data frames 366) may use one or more cycles 350 and may use partial cycles 350.

In some embodiments, channel 346 may be a physical channel that includes a TSCCH and TSDCH. Using cycles 350, control/management frames (e.g., beacon 352, short beacon 356, short beacon 360, short beacon 364, and beacon 368) and data frames (e.g., one or more data frames 354, one or more data frames 358, one or more data frames 362, and one or more data frames 366) may be scheduled to avoid overlapping/conflicting transmissions. Such enhanced coordination may facilitate WTSN communications which meet the latency and reliability requirements of WTSN operations.

It is understood that the aforementioned example is for purposes of illustration and not meant to be limiting.

FIG. 3C depicts an illustrative on-demand channel access sequence 370, in accordance with some embodiments. In some embodiments, AP 372 may be a WTSN device (e.g., WTSN device 150 of FIG. 1B) in communication with STA 374, which may be another WTSN device. AP 372 and STA 374 may use channel 376 to transmit both control/management frames and data frames.

In some embodiments, a beacon period 378 (e.g., 100× cycle time) having one or more cycles 380 may begin with AP 372 sending beacon 382. Later in beacon period 378, AP 372 and/or STA 374 may send one or more data frames 384. AP 372 may send short beacon 386. AP 372 and/or STA 374 may send one or more data frames 388. AP 372 may send short beacon 390. AP 372 and/or STA 374 may send one or more data frames 392. After beacon period 378 has concluded, AP 372 may send another beacon 394 to begin another beacon period. The beacons (e.g., beacon 382, short beacon 386, short beacon 390, and beacon 394) may be sent in channel 376. The one or more data frames (e.g., one or more data frames 384, one or more data frames 388, and one or more data frames 392) may be sent in the channel 376.

In some embodiments, AP 372 may send control/management frames (e.g., beacon 382, short beacon 386, short beacon 390, and beacon 394) on demand using resources such as time slots (e.g., cycles 380) that may not be reserved for time sensitive data.

It is understood that the aforementioned example is for purposes of illustration and not meant to be limiting.

Emerging time-sensitive (TS) applications represent new markets for Wi-Fi. Industrial automation, robotics, augmented reality (AR)/virtual reality (VR) and HMIs (Human-Machine Interface) are example applications. IEEE TSN (Time-Sensitive Networking) standards are being extended over Wi-Fi and 5G to provide the determinism required by many applications in industrial, enterprise and consumer domains. TSN features over Wi-Fi will need more efficient scheduling capabilities from the 802.11 MAC. Although 802.11ax has introduced new triggered-based OFDMA operation, the overhead involved in the basic trigger-based data exchange within a TXOP is high, especially for small packet sizes. Many time-sensitive applications involve isochronous (cyclic) transmission of small packets (typically a few bytes) within very short cycles with high reliability. Embodiments disclosed herein utilize a Synchronized Transmission Opportunity (S-TXOP).

Example embodiments of the present disclosure relate to systems, methods, and devices for a Mechanism to Signal Configuration and Resource Allocation inside a S-TXOP. This disclosure describes resource allocation and configuration signaling enhancements for the S-TXOP including:
A mechanism to signal S-TXOP configuration options in a beacon or other management frames and associate S-TXOP with restricted TWT service periods.
A STA info list field including scheduling information for STAs within each S-TXOP slot.
Signaling to indicate/enable or disable semi-static scheduling configuration within a S-TXOP.
DL-SIG field for DL slots within a S-TXOP.
UL slot control signaling and configuration options.

The proposed enhancements will enable a more efficient configuration and management of network resources within the S-TXOP with better performance (e.g. lower latency and higher efficiency) and protection from interference from other STAs.

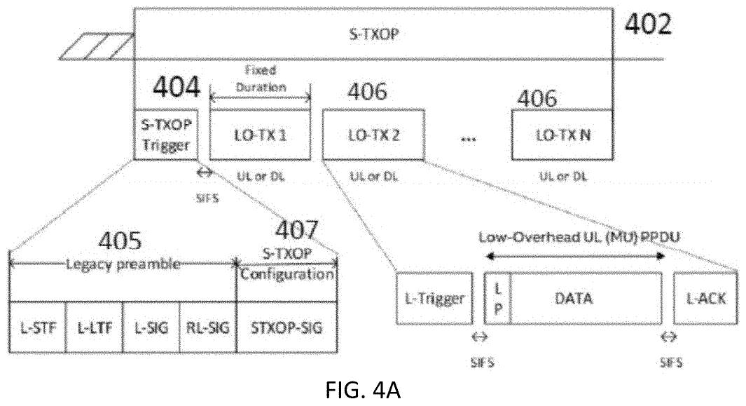

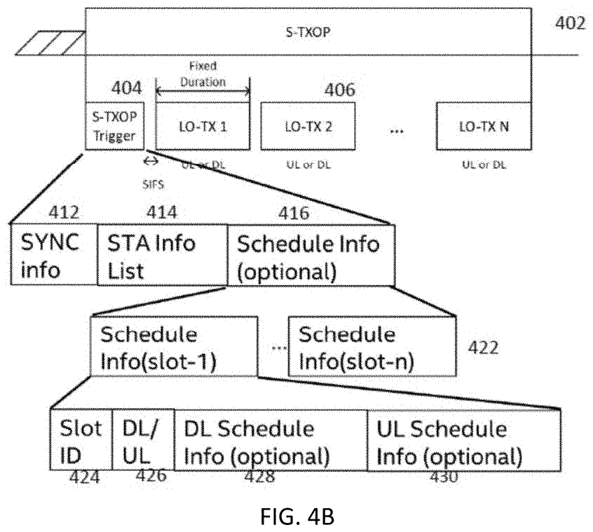

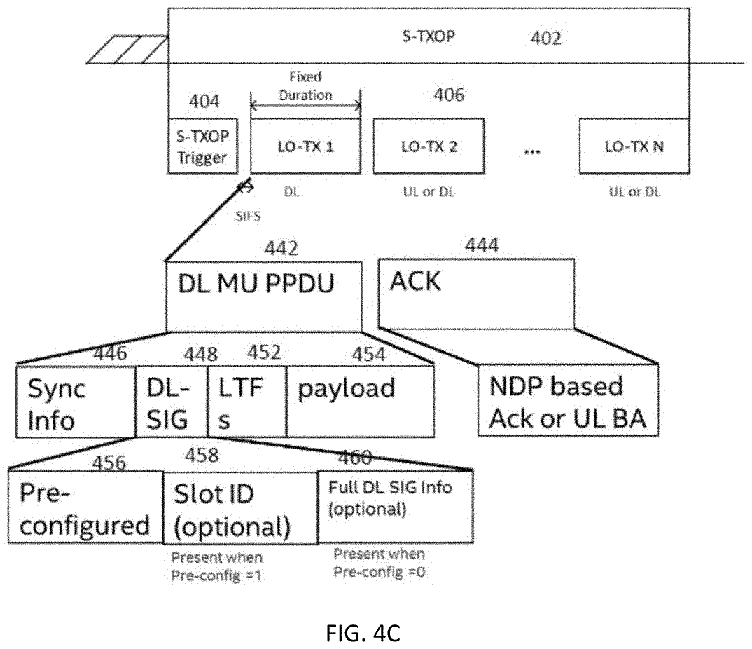

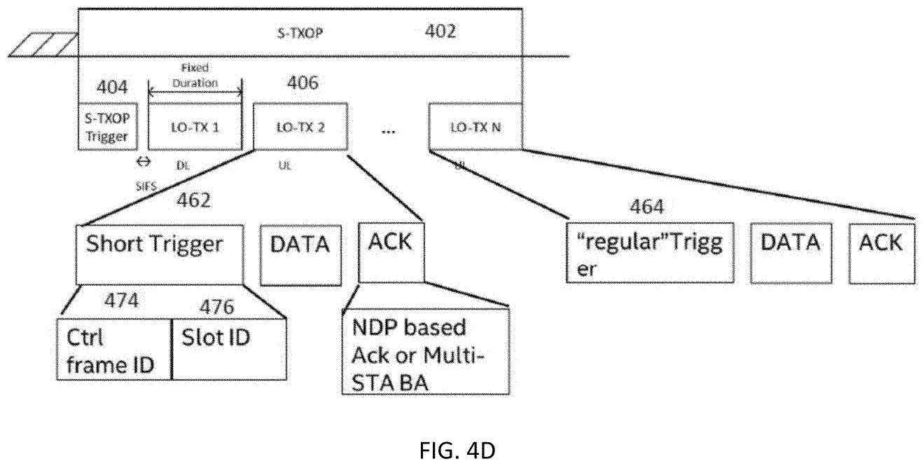

FIG. 4A illustrates an synchronous transmission opportunity (S-TXOP) 402, in accordance with some embodiments. FIG. 4A describes the detailed frame formats for enabling an S-TXOP 402 in a compatible way with legacy Wi-Fi (802.11ax). The specific signaling options to communicate S-TXOP configurations and detailed resource allocation between AP and STAs are described in more detail herein.

As shown in FIG. 4A, S-TXOP 402 may include an S-TXOP trigger 404 for transmission at a beginning of the S-TXOP 402 followed by a plurality of slots 406. The S-TXOP trigger 404 may include a legacy preamble 405 and optionally a S-TXOP configuration field 407. The S-TXOP configuration field 407 may include a number of slots and a duration. In these embodiments, to reduce overhead for coexistence, a first transmission in the S-TXOP 402 may comprise a legacy preamble 405 for enabling coexistence with legacy devices.

S-TXOP Synchronization: STAs may use the S-TXOP trigger 404 (S-TXOP trigger frame (TF)) to synchronize to the AP for the whole S-TXOP time and only a minimum synchronization/AGC correction may be provided in each low overhead PPDU.
Configuration Signalling: Configuration information and resource allocation for the N transmissions opportunities within the S-TXOP.
Lite Trigger (L-Trigger): A low overhead trigger frame to provide/update resource allocations. It includes only the Light Preamble and a field for UL resource allocations.
Lite Preamble: Small Preamble (one OFDM Symbol) carried by a Low Overhead PPDU to enable STAs to correct small timing/frequency jitter that may occur between DL/UL transitions with the S-TXOP. It does not carry the legacy preamble (L-STF, L-LTF, L-SIG, RL-SIG).
Lite-ACK: A low overhead ACK including only the lite preamble and an ARQ bitmap. Normal ACK may also be used.

Some S-TXOP parameters may be configured for all the STAs in the BSS, such as maximum/minimum durations per slot, configuration options for slots (e.g., short trigger vs regular trigger for UL slots). Such configurations may be included in beacon frames or probe response frames.

FIG. 4B illustrates S-TXOP Initial Configuration and Resource Allocation signaling, in accordance with some embodiments.
The SYNC info field 412 enables PHY level synchronization.
STA Info List 414: For each STA that is going to be addressed in this S-TXOP the following information is included:
   The AID.
   The slots these STAs are going to participate in, signaled as:
   Bitmap or
   index of a feasible allocation configured apriori (e.g., during r-TWT setup).
   2 bits to signal if semi-static config is enabled, disabled one or if configuration continues from previous S-TXOP.
Schedule Info 416 contains a list 422 of schedule information for a subset of slots including:
   Slot ID 424
   DL/UL bit 426 or a 2 bit DL/UL/flexible signaling.
   Scheduling IE for DL, UL or P2P:
   The DL Schedule Info 428 contains equivalent of/compressed U-SIG+EHT-SIG information that's carried in MU PPDU.
   UL Schedule Info 430 contains equivalent of/compressed Basic Trigger Frame information.
   Some optimizations can be done e.g., by using index of the STA in the STA Info list instead of AID, getting rid of information that's not useful.
   No Schedule Info if corresponding to a slot in which only STAs that are configured in semi-static fashion participate.
   No DL Schedule Info or UL schedule info if the config is known a priori.

For transmission in slots that are not mentioned in Schedule Info the resource allocation is signaled in the slot (e.g., via a U-SIG or equivalent for DL and TF or short TF in UL).

FIG. 4C illustrates an S-TXOP DL Slot Configuration, in accordance with some embodiments. The SYNC info field 446 enables PHY level synchronization for the DL slot that includes DL MU PPDU 442. In a given slot for a DL transmission a Pre-Configured Bit 456 is included in the DL-SIG 448. If the bit is set to 1, then this signals the allocation was done apriori and the Slot ID field 458 is present as reference to the exact resource allocation. Otherwise, the complete resource allocation information that would typically be present in a baseline DL PPDU (or equivalent) is included (as field 460).

In some embodiments, for a DL slot, the DL MU PPDU 442 may be encoded to include a synchronization field 446 prior to the DL-SIG 448, an LTF 452 following the DL-SIG 448 followed by a payload 454, although the scope of the embodiments is not limited in this respect. ACK 444 may follow the DL MU PPDU 442.

FIG. 4D illustrates an S-TXOP UL Slot Configuration, in accordance with some embodiments. In a given slot for a UL transmission either a Short Trigger 462 is included if the allocation was signaled apriori or a regular Trigger frame 464 otherwise. The Short Trigger can be a new Ctrl frame 474 or a new NDP PPDU. It contains a Slot ID 476 which acts as a pointer to the exact resource allocation.

It is understood that the above descriptions are for purposes of illustration and are not meant to be limiting.
In some embodiments, for S-TXOP resource allocation, some S-TXOP parameters, such as slot durations, may be included in beacon or probe response frames. In some embodiments, signalling may be included inside an S-TXOP to indicate the STAs which are going to be scheduled and in which slots the STAs are scheduled. In some embodiments, an allocation may be signalling for each STA in a slot by providing the index of a feasible allocation configured a-priori, for example.

In some embodiments, the allocation may be changed flexibly without disrupting existing communications. In some embodiments, the allocation information may be provided in terms of a slot ID. Some embodiments address configuring parameters in the DL and the UL can be semi-statically and configuring parameters that may vary between different S-TXOPs.

In some embodiments, an initial allocation may be performed using a management frame exchange. In some embodiments, the initial part of an S-TXOP may be used by the AP to signal a new allocation or to update an allocation. In some embodiments, some parameters, such as transmit (Tx) power may be dynamically signaled in the S-TXOP even if the rest of the resource allocation is configured a-priori. These embodiments are discussed in more detail herein. In some embodiments, semi-static allocation parameters are signaled to a STA reliably using a management frame exchange by associating an allocation index to each allocation.

In some embodiments, during operation within an S-TXOP, an AP may signal a set of allocations to be used during the S-TXOP and the time-windows in which each allocation is expected. It should be noted that not all time-windows need to be mapped to an allocation. Embodiments disclosed here do not disallow transmissions of regular (i.e., with full preamble and allocation content) PPDUs during a time-window to which an allocation is mapped.

In some embodiments, the schedule information for periodic allocations are included within the S-TXOP. In some embodiments, if an allocation has changed or for a new allocation, an entire new allocation may be included (e.g., in an S-TXOP trigger). When an allocation has not changed, a pointer to a prior allocation may be included. In some embodiments, a pointer may be used to indicate one or more dynamic parameters, although the scope of the embodiments is not limited in this respect.

In some embodiments, every time an allocation changes, addition or removal information may be communicated via the new allocation including the index reliably via a management frame exchange. The management frame exchange may be performed in-band or out-of-band (OOB).

In some embodiments, for each allocation signaled in S-TXOP Trigger, the AP may signal periodic time-windows (i.e., “slots”) in which the allocation is valid by including the start slot and periodicity information. In some embodiments, a map may be sent or signaled. In these embodiments, the map be defined out-of-band (OOB) and/or an index to the map may be signaled. In these embodiments, the map may identify which slots are DL and which UL, and which STA is expected to be available for which slot. In case of multi-user (MU) transmissions, the specific OFDMA RU allocations or MU MIMO Spatial Stream ID may be pre-allocated, although the scope of the embodiments is not limited in this respect.

In some embodiments, for each allocation signaled in an S-TXOP Trigger, the AP may signal the index of an allocation within a pre-configured table. The index itself may jointly signal the slot pattern, the STAs that are going to participate in it as well as the individual resource allocation within those slots. In some embodiments, for each allocation signaled in S-TXOP Trigger, the AP may signal the time-windows in which the allocation is valid by including the bitmap of the slots.

In some embodiments, the following DL-MU parameters (non-inclusive) may vary dynamically across S-TXOPs and may be optionally provided upfront in the S-TXOP Trigger for each DL allocation: padding, LDPC extra symbol segments, PE Disambiguate. In some embodiments, the following UL-MU parameters (non-inclusive) may vary dynamically across S-TXOPs and may be optionally provided upfront in the S-TXOP Trigger for each UL allocation: padding, AP Tx power, UL Target Receive Power, RU Allocation, MU MIMO Spatial Stream ID.

In some embodiments, the allocation index for a set of STAs in the S-TXOP Trigger and within a slot can be achieved by using a group ID corresponding uniquely to those set of STAs. Each group ID may correspond to one allocation.

In some embodiments, if a complete allocation is signaled in an S-TXOP Trigger, the allocation is assumed to be valid only within that S-TXOP (or repeated for a few subsequent S-TXOPs). In these embodiments, the allocation may take precedence over any other allocation with the same allocation index. In some embodiments, instead of including the entire allocation in a next S-TXOP Trigger, the AP may use a bit to signal that this allocation is same as one used before. Before using the same allocation in a different S-TXOP without repeating the entire content, the AP may reliably communicate this to all the involved STAs. In some of these embodiments, a repeat bit may be used, although the scope of the embodiments is not limited in this respect.

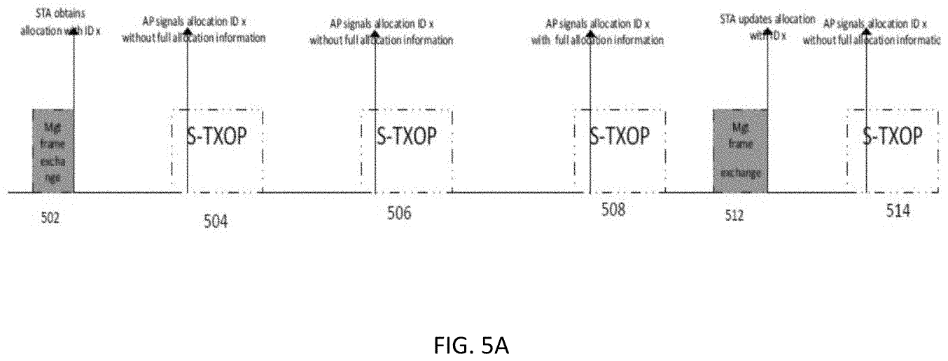

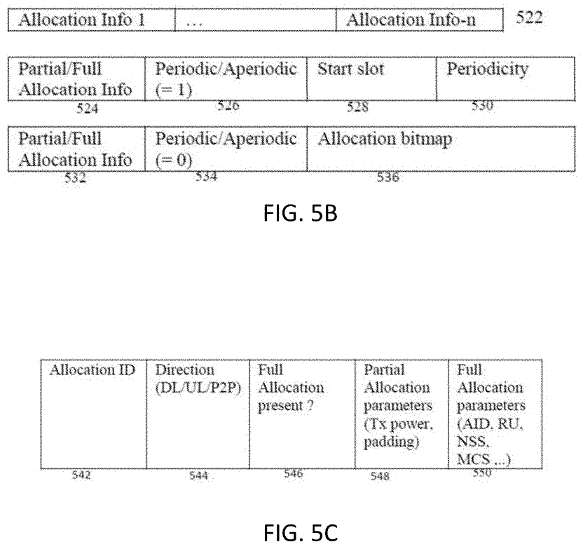

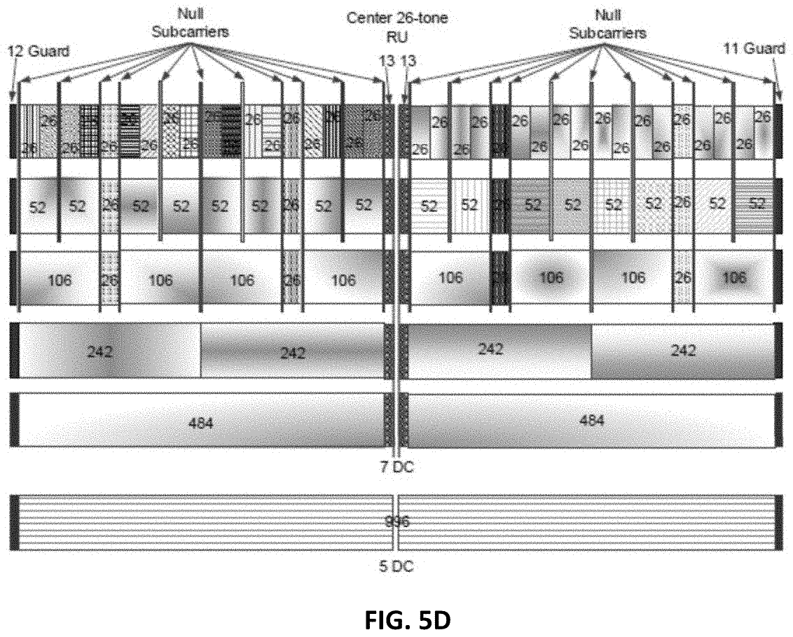

FIG. 5A shows an example of how to update an S-TXOP allocation. First, the AP informs the STAs about the full allocation information associated with an allocation ID x during a Management frame exchange 502. Then for subsequent S-TXOPs (i.e., TXOPs 504 and 506) the AP just provides the allocation index in an S-TXOP Trigger without the full allocation information. In S-TXOP 508, for example, the AP signals the full allocation information along with the allocation ID since it may need to change the allocation corresponding to index x. As illustrated in FIG. 5A, the AP and STAs perform another Management frame exchange 512 before the AP can use the allocation with ID x without providing the full allocation in S-TXOP 514.

FIG. 5B shows an example of providing schedule and allocation info inside an S-TXOP Trigger. The allocation for DL and/or UL slots is contained in the Partial/Full Allocation Info field 524 whose content is described in FIG. 5C.

As illustrated in FIG. 5B, the signaling of periodic and aperiodic schedule info is associated with an allocation ID 522. An example format of allocation Info field is illustrated in FIG. 5C. Full allocation parameters may be present when the full allocation present bit (i.e., field 546) is set.

Some embodiments are directed to an access point station (AP) configured to communicate with a plurality of non-AP stations (STAs) within synchronized transmission opportunities (S-TXOPs). In these embodiments, the AP may perform an initial management frame exchange 502 with the STAs. During the initial management frame exchange 502, one or more sets of semi-static allocation parameters are signalling to the STAs and each set of semi-static allocation parameters associated with an allocation index (IDx). In these embodiments, the AP may communicate data with the STAs during S-TXOPs that follow the initial management frame exchange 502. In these embodiments, each of the S-TXOPs includes an S-TXOP trigger 404 encoded to include: allocation indices to indicate a known allocation for use during the associated S-TXOP (e.g., TXOP 504 and TXOP 506) when a set of the predetermined semi-static allocation parameters are to be used; or full allocation information to indicate a new allocation for use during the associated S-TXOP (e.g., TXOP 508) when the predetermined semi-static allocation parameters are not used. In these embodiments, the AP may communicate data with the STAs during the S-TXOPs that follow the initial management frame exchange 502 in accordance with either one of the known allocations indicated in the associated S-TXOP trigger or the new allocation included in the associated S-TXOP trigger.

In some embodiments, in response to changing network conditions including changing associations of the STAs (i.e., one or more STAs leaving or joining), the AP may perform a subsequent management frame exchange 512 to signal one or more new sets of semi-static allocation parameters to one or more of the STAs (i.e., to update the allocation information). The AP may then communicate data with the STAs during one or more of the S-TXOPs 514 that follow the subsequent management frame exchange 512 by including an allocation index of an allocation determined during the subsequent management frame exchange 514 in an S-TXOP trigger of the one or more of the S-TXOPs 514 that follow the subsequent management frame exchange 512. In these embodiments, the one or more new sets of semi-static allocation parameters may be signalling to a new set of one or more of the STAs, and data may be communicating with the new set of one or more STAs during one or more subsequent TXOPs (i.e., TXOP 514) following management frame exchange 512.

In some embodiments, each S-TXOP 402 comprises an S-TXOP trigger 404 followed by a plurality of periodic time-slots 406 (e.g., time windows). In some embodiments, the known allocation corresponds one of the sets of the predetermined semi-static allocation parameters signaled during the initial management frame exchange 502). In some embodiments, each set of the semi-static allocation parameters comprise complete or full allocation information for use in a subsequent one or more of the S-TXOPs.

In some embodiments, the S-TXOP trigger 404 is encoded to indicate time slot validity by indicating a start slot 528 and periodicity information 530 of the plurality of time-slots. An example of this is illustrated in FIG. 5B which illustrates the signaling periodic and aperiodic schedule information associated with an allocation identifier (ID) 522. As illustrated in FIG. 5B, S-TXOP trigger may include field 524 which may indicate whether a partial or full allocation is present, field 526 which may indicate whether the allocation is periodic, a field 528 to indicate the start slot, and a field 530 to include the periodicity information (when the allocation is periodic). In some embodiments, the time-slots in which a S-TXOP is valid may be signalling by the inclusion of a bitmap of the slots. As illustrated in FIG. 5B, field 532 may indicate whether a partial or full allocation is present, field 534 may indicate whether the allocation is periodic, and field 536 may include an allocation bitmap, although the scope of the embodiments is not limited in this respect.

In some embodiments, the allocation index that is included in the S-TXOP trigger is signaled (i.e., encoded in the S-TXOP trigger) within a pre-configured table, the allocation index jointly signalling: a slot pattern of the time slots within the S-TXOP; the one or more STAs that are participating in the S-TXOP; and individual resource unit (RU) allocations within the time slots that are assigned to the one or more participating STAs.

In some embodiments, to dynamically vary one or more allocation parameters across a set of S-TXOPs in which the semi-static allocation parameters are signaled by an allocation index, the AP may encode the S-TXOP trigger to indicate which of the one or more partial allocation parameters 548 vary.

In some embodiments, to dynamically vary one or more downlink multi-user (DL-MU) allocation parameters for one or more downlink slots of an S-TXOP, the AP may encode an S-TXOP trigger of the S-TXOP to indicate one or more allocation parameters for each downlink allocation including one or more of: padding, LDPC extra symbol segments, and PE Disambiguate.

In some embodiments, to dynamically vary one or more uplink multi-user (UL-MU) allocation parameters for one or more uplink slots of an S-TXOP, the AP may encode an S-TXOP trigger of the S-TXOP to indicate one or more allocation parameters for each uplink allocation including one or more of: padding, AP Tx power, UL Target Receive Power, RU Allocation, and a MU-MIMO Spatial Stream ID.

As illustrated in FIG. 5C, the format of allocation information field for use in an S-TXOP trigger, and may include an allocation ID 542, a field 544 to indicate whether the S-TXOP is for DL, UL or P2P, a field 546 to indicate whether a full or a partial allocation is present in the S-TXOP trigger, a field 548 that includes partial allocation parameters (when indicated by field 546) and a field 550 that includes full allocation parameters (when indicated by field 546), although the scope of the embodiments is not limited in this respect.

In some embodiments, the allocation index signaled in the S-TXOP trigger is associated with a group of STAs of the plurality of STAs. In some embodiments, during the initial management frame exchange 502, one or more group IDs are determined. In some embodiments, each of the one or more group IDs are configurable to correspond to a different set (i.e., a subgroup) of the STAs to indicate a resource allocation within one or more of the time slots of the S-TXOP. In these embodiments, a group ID may be used to indicate a single (i.e., one) allocation for a set of stations during one of the time slots. For example, the AP may group STA-1, STA-2 to share a DL OFDMA transmission within a time slot by allocating the same group ID x to both STAs. During the setup phase, STA-1 would therefore know that allocation ID x means it will get a specific allocation (e.g., the first 40 MHz RU in a 80 MHz BW transmission), while STA-2 would know that allocation ID x means it will get a specific allocation (i.e., the second 40 MHz RU in the 80 MHz BW transmission) of a DL MU transmission. FIG. 5D illustrates some example resource unit (RU) locations in an 80 MHz bandwidth (BW) transmission. Other bandwidth transmissions are also suitable.

In some embodiments, when the AP encodes an S-TXOP Trigger of an S-TXOP (e.g., S-TXOP 508) to signal full allocation information, the AP ma also indicate, with a single bit in an S-TXOP trigger of a following S-TXOP, whether the previously signaled full allocation information is to be used for the following 5-TXOP. In these embodiments, the full allocation information that was signaled in a S-TXOP trigger of a prior S-TXOP may be used in a subsequent S-TXOP without the need to repeat the content of the full allocation information. In these embodiments, full allocation information may be reliably communicating to the STAs participating in the S-TXOP.

Some embodiments are directed to a non-transitory computer-readable storage medium that stores instructions for execution by processing circuitry of an access point station (AP). To configure the AP to communicate with a plurality of non-AP stations (STAs) within synchronized transmission opportunities (S-TXOPs), the processing circuitry may cause the AP to perform an initial management frame exchange 502 with the STAs. During the initial management frame exchange 502, one or more sets of semi-static allocation parameters are signalling to the STAs. Each set of semi-static allocation parameters may be associated with an allocation index (IDx). The AP may communicate data with the STAs during S-TXOPs that follow the initial management frame exchange 502. Each of the S-TXOPs includes an S-TXOP trigger 404 encoded to include: one of the allocation indices to indicate a known allocation for use during the associated S-TXOP (e.g., TXOP 504 and TXOP 506) when a set of the predetermined semi-static allocation parameters are to be used; and full allocation information to indicate a new allocation for use during the associated S-TXOP (e.g., TXOP 508) when the predetermined semi-static allocation parameters are not used.

Some embodiments are directed to a method performed by processing circuitry of an access point station (AP) to configure the AP to communicate with a plurality of non-AP stations (STAs) within synchronized transmission opportunities (S-TXOPs). These embodiments are described in more detail herein.

FIG. 6 illustrates a functional block diagram of a wireless communication device, in accordance with some embodiments. In one embodiment, FIG. 6 illustrates a functional block diagram of a communication device (STA) that may be suitable for use as an AP STA, a non-AP STA or other user device in accordance with some embodiments. The communication device 600 may also be suitable for use as a handheld device, a mobile device, a cellular telephone, a smartphone, a tablet, a netbook, a wireless terminal, a laptop computer, a wearable computer device, a femtocell, a high data rate (HDR) subscriber device, an access point, an access terminal, or other personal communication system (PCS) device.

The communication device 600 may include communications circuitry 602 and a transceiver 610 for transmitting and receiving signals to and from other communication devices using one or more antennas 601. The communications circuitry 602 may include circuitry that can operate the physical layer (PHY) communications and/or medium access control (MAC) communications for controlling access to the wireless medium, and/or any other communications layers for transmitting and receiving signals. The communication device 600 may also include processing circuitry 606 and memory 608 arranged to perform the operations described herein. In some embodiments, the communications circuitry 602 and the processing circuitry 606 may be configured to perform operations detailed in the above figures, diagrams, and flows.

In accordance with some embodiments, the communications circuitry 602 may be arranged to contend for a wireless medium and configure frames or packets for communicating over the wireless medium. The communications circuitry 602 may be arranged to transmit and receive signals. The communications circuitry 602 may also include circuitry for modulation/demodulation, upconversion/downconversion, filtering, amplification, etc. In some embodiments, the processing circuitry 606 of the communication device 600 may include one or more processors. In other embodiments, two or more antennas 601 may be coupled to the communications circuitry 602 arranged for sending and receiving signals. The memory 608 may store information for configuring the processing circuitry 606 to perform operations for configuring and transmitting message frames and performing the various operations described herein. The memory 608 may include any type of memory, including non-transitory memory, for storing information in a form readable by a machine (e.g., a computer). For example, the memory 608 may include a computer-readable storage device, read-only memory (ROM), random-access memory (RAM), magnetic disk storage media, optical storage media, flash-memory devices and other storage devices and media.

In some embodiments, the communication device 600 may be part of a portable wireless communication device, such as a personal digital assistant (PDA), a laptop or portable computer with wireless communication capability, a web tablet, a wireless telephone, a smartphone, a wireless headset, a pager, an instant messaging device, a digital camera, an access point, a television, a medical device (e.g., a heart rate monitor, a blood pressure monitor, etc.), a wearable computer device, or another device that may receive and/or transmit information wirelessly.

In some embodiments, the communication device 600 may include one or more antennas 601. The antennas 601 may include one or more directional or omnidirectional antennas, including, for example, dipole antennas, monopole antennas, patch antennas, loop antennas, microstrip antennas, or other types of antennas suitable for transmission of RF signals. In some embodiments, instead of two or more antennas, a single antenna with multiple apertures may be used. In these embodiments, each aperture may be considered a separate antenna. In some multiple-input multiple-output (MIMO) embodiments, the antennas may be effectively separated for spatial diversity and the different channel characteristics that may result between each of the antennas and the antennas of a transmitting device.

In some embodiments, the communication device 600 may include one or more of a keyboard, a display, a non-volatile memory port, multiple antennas, a graphics processor, an application processor, speakers, and other mobile device elements. The display may be an LCD screen including a touch screen.

Although the communication device 600 is illustrated as having several separate functional elements, two or more of the functional elements may be combined and may be implemented by combinations of software-configured elements, such as processing elements including digital signal processors (DSPs), and/or other hardware elements. For example, some elements may include one or more microprocessors, DSPs, field-programmable gate arrays (FPGAs), application specific integrated circuits (ASICs), radio-frequency integrated circuits (RFICs) and combinations of various hardware and logic circuitry for performing at least the functions described herein. In some embodiments, the functional elements of the communication device 600 may refer to one or more processes operating on one or more processing elements.

In some embodiments, a physical layer protocol data unit may be a physical layer conformance procedure (PLCP) protocol data unit (PPDU). In some embodiments, the AP and STAs may communicate in accordance with one of the IEEE 802.11 standards. IEEE 802.11-2016 is incorporated herein by reference. IEEE P802.11-REVmd/D2.4, August 2019, and IEEE draft specification IEEE P802.11ax/D5.0, October 2019 are incorporated herein by reference in their entireties. In some embodiments, the AP and STAs may be directional multi-gigabit (DMG) STAs or enhanced DMG (EDMG) STAs configured to communicate in accordance with IEEE 802.11ad standard or IEEE draft specification IEEE P802.11ay, February 2019, which is incorporated herein by reference.

The following patent applications are incorporated by reference:

PCT/US2017/067134, Filed Dec. 18, 2017, Published Jun. 27, 2019 as WO2019/125396, and entitled “ENHANCED TIME SENSITIVE NETWORKING FOR WIRELESS COMMUNICATIONS” [Ref No. AA5687-PCT];

PCT/US2018/035868, Filed Jun. 4, 2018, Published Dec. 12, 2019 as WO2019/236052, entitled “METHODS AND APPARATUS TO FACILITATE A SYNCHRONOUS TRANSMISSION OPPORTUNITY IN A WIRELESS LOCAL AREA NETWORK” [Ref No. AA8799-PCT];

U.S. Ser. No. 16/870,156, Filed May 8, 2020, Published as US2020-0267636 A1, entitled “EXTREME HIGH THROUGHPUT (EHT) TIME-SENSITIVE NETWORKING” [Ref No. AC2096-US].

The Abstract is provided to comply with 37 C.F.R. Section 1.72(b) requiring an abstract that will allow the reader to ascertain the nature and gist of the technical disclosure. It is submitted with the understanding that it will not be used to limit or interpret the scope or meaning of the claims. The following claims are hereby incorporated into the detailed description, with each claim standing on its own as a separate embodiment.

What is claimed is:

1. An apparatus of an access point station (AP), the apparatus comprising: processing circuitry; and memory,
wherein to configure the AP to communicate with a plurality of non-AP stations (STAs) within synchronized transmission opportunities (S-TXOPs), the processing circuitry is configured to:
perform an initial management frame exchange with the STAs, wherein during the initial management frame exchange, one or more sets of semi-static allocation parameters are signalling to the STAs, each set associated with an allocation index (IDx); and
communicate with the STAs during S-TXOPs that follow the initial management frame exchange,
wherein each of the S-TXOPs includes an S-TXOP trigger encoded to include:
one of the allocation indices to indicate a known allocation for use during the associated S-TXOP when the semi-static allocation parameters are to be used; and
full allocation information to indicate a new allocation for use during the associated S-TXOP when the semi-static allocation parameters are not used.

2. The apparatus of claim 1, wherein in response to changing network conditions including changing associations of the STAs, the processing circuitry is configured to:
perform a subsequent management frame exchange to signal one or more new sets of semi-static allocation parameters to one or more of the STAs; and
communicate with the STAs during one or more of the S-TXOPs that follow the subsequent management frame exchange by including an allocation index of an allocation determined during the subsequent management frame exchange in an S-TXOP trigger of the one or more of the S-TXOPs that follow the subsequent management frame exchange.

3. The apparatus of claim 1, wherein each S-TXOP comprises an S-TXOP trigger followed by a plurality of time-slots,
wherein the known allocation corresponds one of the sets of the semi-static allocation parameters signaled during the initial management frame exchange),
wherein each set of the semi-static allocation parameters comprise complete allocation information for use in a subsequent one or more of the S-TXOPs.

4. The apparatus of claim 3, wherein the S-TXOP trigger is encoded to indicate a start slot and periodicity information of the plurality of time-slots.

5. The apparatus of claim 3, wherein the allocation index that is included in the S-TXOP trigger is signaled within a pre-configured table, the allocation index signalling:
a slot pattern of the time slots within the S-TXOP;
the one or more STAs that are participating in the S-TXOP; and
individual resource unit (RU) allocations within the time slots that are assigned to the one or more STAs.

6. The apparatus of claim 3, wherein to dynamically vary one or more allocation parameters across a set of S-TXOPs in which the semi-static allocation parameters are signaled by an allocation index, the processing circuitry is configured to encode the S-TXOP trigger to indicate which of the one or more allocation parameters vary.

7. The apparatus of claim 6, wherein to dynamically vary one or more downlink multi-user (DL-MU) allocation parameters for one or more downlink slots of an S-TXOP, the processing circuitry is configured to encode an S-TXOP trigger of the S-TXOP to indicate one or more allocation parameters for each downlink allocation including one or more of: padding, LDPC extra symbol segments, and PE Disambiguate.

8. The apparatus of claim 6, wherein to dynamically vary one or more uplink multi-user (UL-MU) allocation parameters for one or more uplink slots of an S-TXOP, the processing circuitry is configured to encode an S-TXOP trigger of the S-TXOP to indicate one or more allocation parameters for each uplink allocation including one or more of: padding, AP Tx power, UL Target Receive Power, RU Allocation, and a MU-MIMO Spatial Stream ID.

9. The apparatus of claim 3, wherein the allocation index signaled in the S-TXOP trigger is associated with a group of STAs of the plurality of STAs, and
wherein during the initial management frame exchange, one or more group IDs are determined, wherein each of the one or more group IDs are configurable to correspond to a different set of the STAs to indicate a resource allocation within one or more of the time slots of the S-TXOP.

10. The apparatus of claim 3, wherein when the processing circuitry encodes an S-TXOP Trigger of an S-TXOP to signal full allocation information, the processing circuitry is further configured to indicate, with a bit in an S-TXOP trigger of a following S-TXOP, whether the full allocation information is to be used for the following S-TXOP.

11. A non-transitory computer-readable storage medium that stores instructions for execution by processing circuitry of an access point station (AP), wherein to configure the AP to communicate with a plurality of non-AP stations (STAs) within synchronized transmission opportunities (S-TXOPs), the processing circuitry is configured to:
perform an initial management frame exchange with the STAs, wherein during the initial management frame exchange, one or more sets of semi-static allocation parameters are signalling to the STAs, each set associated with an allocation index (IDx); and
communicate with the STAs during S-TXOPs that follow the initial management frame exchange,
wherein each of the S-TXOPs includes an S-TXOP trigger encoded to include:
one of the allocation indices to indicate a known allocation for use during the associated S-TXOP when the semi-static allocation parameters are to be used; and
full allocation information to indicate a new allocation for use during the associated S-TXOP when the semi-static allocation parameters are not used.

12. The non-transitory computer-readable storage medium of claim 11, wherein in response to changing network conditions including changing associations of the STAs, the processing circuitry is configured to:
perform a subsequent management frame exchange to signal one or more new sets of semi-static allocation parameters to one or more of the STAs; and
communicate with the STAs during one or more of the S-TXOPs that follow the subsequent management frame exchange by including an allocation index of an allocation determined during the subsequent management frame exchange in an S-TXOP trigger of the one or more of the S-TXOPs that follow the subsequent management frame exchange.

13. The non-transitory computer-readable storage medium of claim 11, wherein each S-TXOP comprises an S-TXOP trigger followed by a plurality of time-slots,
wherein the known allocation corresponds one of the sets of the semi-static allocation parameters signaled during the initial management frame exchange),
wherein each set of the semi-static allocation parameters comprise complete allocation information for use in a subsequent one or more of the S-TXOPs.

14. The non-transitory computer-readable storage medium of claim 13, wherein the S-TXOP trigger is encoded to indicate a start slot and periodicity information of the plurality of time-slots.

15. The non-transitory computer-readable storage medium of claim 13, wherein the allocation index that is included in the S-TXOP trigger is signaled within a pre-configured table, the allocation index signalling:
a slot pattern of the time slots within the S-TXOP;
the one or more STAs that are participating in the S-TXOP; and
individual resource unit (RU) allocations within the time slots that are assigned to the one or more STAs.

16. The non-transitory computer-readable storage medium of claim 13, wherein to dynamically vary one or more allocation parameters across a set of S-TXOPs in which the semi-static allocation parameters are signaled by an allocation index, the processing circuitry is configured to encode the S-TXOP trigger to indicate which of the one or more allocation parameters vary.

17. The non-transitory computer-readable storage medium of claim 16, wherein to dynamically vary one or more downlink multi-user (DL-MU) allocation parameters for one or more downlink slots of an S-TXOP, the processing circuitry is configured to encode an S-TXOP trigger of the S-TXOP to indicate one or more allocation parameters for each downlink allocation including one or more of: padding, LDPC extra symbol segments, and PE Disambiguate.

18. The non-transitory computer-readable storage medium of claim 16, wherein to dynamically vary one or more uplink multi-user (UL-MU) allocation parameters for one or more uplink slots of an S-TXOP, the processing circuitry is configured to encode an S-TXOP trigger of the S-TXOP to indicate one or more allocation parameters for each uplink allocation including one or more of: padding, AP Tx power, UL Target Receive Power, RU Allocation, and a MU-MIMO Spatial Stream ID.

19. A method performed by processing circuitry of an access point station (AP), wherein to configure the AP to communicate with a plurality of non-AP stations (STAs) within synchronized transmission opportunities (S-TXOPs), the method comprises:
performing an initial management frame exchange with the STAs, wherein during the initial management frame exchange, one or more sets of semi-static allocation parameters are signalling to the STAs, each set associated with an allocation index (IDx); and
communicating with the STAs during S-TXOPs that follow the initial management frame exchange,
wherein each of the S-TXOPs includes an S-TXOP trigger encoded to include:
one of the allocation indices to indicate a known allocation for use during the associated S-TXOP when the semi-static allocation parameters are to be used; and
full allocation information to indicate a new allocation for use during the associated S-TXOP when the semi-static allocation parameters are not used.

20. The method of claim 19, wherein in response to changing network conditions including changing associations of the STAs, the method comprises:
performing a subsequent management frame exchange to signal one or more new sets of semi-static allocation parameters to one or more of the STAs; and
communicating with the STAs during one or more of the S-TXOPs that follow the subsequent management frame exchange by including an allocation index of an allocation determined during the subsequent management frame exchange in an S-TXOP trigger of the one or more of the S-TXOPs that follow the subsequent management frame exchange.
